(19) United States
(12) Patent Application Publication
(10) Pub. No.: US 2024/0227418 A9
(43) Pub. Date: Jul. 11, 2024

(54) PRINTING APPARATUS CAPABLE OF GUIDING AND DISPLAYING INITIAL INSTALLATION, CONTROL METHOD THEREFOR AND STORAGE MEDIUM

(71) Applicant: CANON KABUSHIKI KAISHA, Tokyo (JP)

(72) Inventor: Daiki Takahashi, Kanagawa (JP)

(21) Appl. No.: 18/380,824

(22) Filed: Oct. 17, 2023

(30) Foreign Application Priority Data
Oct. 24, 2022 (JP) 2022-169994

(51) Int. Cl. B41J 11/00; H04N 1/00

(52) U.S. Cl. CPC B41J 11/0095; B41J 11/008; H04N 1/00482

(57) ABSTRACT

A printing apparatus having high operability of initial installation work for a user, which takes the user's behavior at the time of initial installation of the printing apparatus into account. The printing apparatus is capable of detect start of paper loading operation, detect end of the paper loading operation, and display more detailed guide information than guide summary information when the start of the paper loading operation is detected at the time of the initial installation of the printing apparatus. The printing apparatus controls, after the display of the guide information is started, to start printing in a case where the end of the paper loading operation is detected, and not to start printing in a case where the end of the paper loading operation is not detected.

### BACKGROUND OF THE INVENTION

### Field of the Invention

The present invention relates to a printing apparatus capable of guiding and displaying initial installation, a control method therefor and a storage medium.

### Description of the Related Art

A user who purchases a printing apparatus performs initial installation of the printing apparatus after initial power-on of the printing apparatus. The initial installation includes print preparation processes such as ink setup, paper loading, print head positioning, and connection settings with external devices. Japanese Laid-Open Patent Publication (kokai) No. 2019-34447 discloses a technique for switching installation guide display contents according to the area region where the printing apparatus is sold, in order to prevent user error in the initial installation work. For example, information on usage regarding paper sizes for each region is stored as regional information, and when the printing apparatus is installed, an operation guide for installing a paper cassette corresponding to the paper size corresponding to the regional information for the region where the printing apparatus is installed is displayed.

However, the printing apparatus disclosed in Japanese Laid-Open Patent Publication (kokai) No. 2019-34447 provides a guide display for switching the initial installation mode based only on the area where the printing apparatus is sold. Further, in areas where the printing apparatus could not make decisions for switching to prevent erroneous operation, erroneous operation prevention measures could not be provided. That is, the conventional printing apparatus has a problem of not being able to guide (lead) each user appropriately according to the behavior of the user when loading paper.

For example, some initial installation tasks can only be performed by the user if he or she follows the guide displayed by the printing apparatus, while others can be performed with or without guide display. The operation of print head positioning is started only by selecting one to be instructed and executed from the guide display performed by the printing apparatus, whereas paper loading can be performed regardless of guide display. In addition, paper loading must be completed in order to start print head positioning. Therefore, when guide for the print head positioning is displayed, guide for the paper loading is also displayed at the same time.

However, for a user who wants to load paper in advance by referring to the manual without referring to the guide display by the printing apparatus, the guide display for paper loading can be rather troublesome. As described above, the content of the appropriate guide display can depend on the user's behavior at the time of paper loading; however, the printing apparatus disclosed in Japanese Laid-Open Patent Publication (kokai) No. 2019-34447 is not able to switch the guide display according to the user's behavior at the time of paper loading.

In order to solve these problems, the inventor of the present application considered it would be possible to provide only appropriate guide displays without unnecessary guide displays, by taking into account the user's behavior at the time of initial installation of the printing apparatus (especially paper loading) before starting the guide displays for print head positioning and paper loading. To do this, for example, the decision information on whether or not paper has been already loaded is used to make a judgment, and in a case where paper has already been loaded, the guide display for paper loading is not displayed.

### SUMMARY OF THE INVENTION

The present invention provides a printing apparatus, a control method therefor and a storage medium, the printing apparatus having high operability of initial installation work for a user, which takes the user's behavior at the time of initial installation of the printing apparatus (especially paper loading) into account.

Accordingly, the present invention provides a printing apparatus capable of displaying guide summary information for paper loading guide at the time of initial installation of the printing apparatus, the printing apparatus comprising one or more controllers configured to function as: a first detection unit configured to detect start of paper loading operation; a second detection unit configured to detect end of the paper loading operation; a guide display unit configured to display more detailed guide information than the guide summary information in a case where the start of the paper loading operation is detected at the time of the initial installation of the printing apparatus; and a control unit configured to control, after the display of the guide information is started, to start printing in a case where the end of the paper loading operation is detected, and not to start printing in a case where the end of the paper loading operation is not detected.

According to the present invention, it is possible to provide a printing apparatus, a control method therefor and a storage medium, the printing apparatus having high operability of the initial installation work for a user, which takes the user's behavior at the time of initial installation of the printing apparatus (especially paper loading) into account.

Further features of the present invention will become apparent from the following description of exemplary embodiments with reference to the attached drawings.

### BRIEF DESCRIPTION OF THE DRAWINGS

FIG. 1 is an external view of a printing apparatus.

FIG. 2 is a configuration diagram of the printing apparatus.

FIG. 3 is a diagram showing an example of another configuration of the printing apparatus.

FIG. 4 is a flowchart showing an initial installation process executed by the printing apparatus.

FIG. 5 is a flowchart showing a paper loading guide display process in the prior art.

FIG. 6 is a flowchart showing a paper loading guide display process according to a first embodiment.

FIG. 7 is a flowchart showing a paper loading guide display process according to a second embodiment.

FIGS. 8A and 8B are flowcharts for describing a paper loading guide display process according to a third embodiment.

FIGS. 9A and 9B are flowcharts for describing a paper loading guide display process according to a fourth embodiment.

FIG. 10 is an explanatory diagram of various display screens.

### DESCRIPTION OF THE EMBODIMENTS

The present invention will now be described in detail below with reference to the accompanying drawings showing embodiments thereof. However, the configurations described in the following embodiments are merely examples, and the scope of the present invention is not limited by the configurations described in the embodiments.

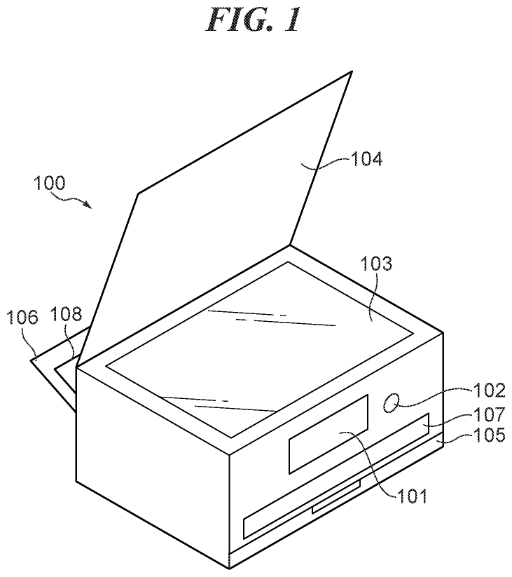

FIG. 1 is an external view of a printing apparatus 100. In the present embodiment, a multifunction peripheral (MFP) in which a plurality of functions such as a scanner function and a print function are integrated is taken as an example of a printing apparatus 100. The printing apparatus 100 has an appearance rectangular parallelepiped/substantially rectangular parallelepiped as a whole. An operation panel 101 and a power button 102 are provided in a substantially central part of the front of the printing apparatus 100, and a wide paper output slot 107 is provided below the operation panel 101 and the power button 102. In addition, a wide paper cassette 105 is removably provided in a front lower part of the printing apparatus 100. A platen 103 on which an original to be printed is to be placed (set) and a platen pressing plate 104 for pressing the original to be printed against the platen 103, are provided on an upper surface (upper part) of the printing apparatus 100. At the rear of the printing apparatus 100, a rear paper tray 106 is provided that can be tilted against the rear, and a rear paper feed slot cover 108 is provided that can be opened and closed against a paper feed slot (not illustrated).

The operation panel 101 displays a screen(s) for displaying the status of the printing apparatus 100, a user interface (UI) screen(s) for making various settings, and the like. Display buttons and the like are provided on the UI screen, and the user can perform various input operations by touching the display buttons and the like with a finger. The power button 102 is a button for switching between “ON” and “OFF” of the power supply of the printing apparatus 100. The paper output slot 107 is a slot for ejecting a printed matter that has been printed as desired. The paper cassette 105 is a cassette for storing paper to be fed.

The platen 103 is a glass-like transparent platform, and is used when an original to be printed such as a document is placed and read by a scanner part. The platen pressing plate 104 is a cover that presses the object to be printed against the platen 103 when the original to be printed is read by the scanner unit to prevent the original to be printed from floating and to prevent external light from entering the scanner unit. The rear paper tray 106 is a tray in which paper fed from the rear of the printing apparatus 100 can be loaded. The rear paper feed slot cover 108 is a cover provided that can be opened and closed with respect to a paper feed slot (not illustrated) of the rear paper tray 106, and is opened and closed at the time of loading paper in the rear paper tray 106, and prevents foreign matter from entering the paper feed slot. In addition, the paper loaded in the paper cassette 105 and the paper loaded in the rear paper tray 106 are conveyed one sheet a time to a printing part (not illustrated in FIG. 1), and a printed matter obtained by being subjected to the desired print is ejected from the paper output slot 107.

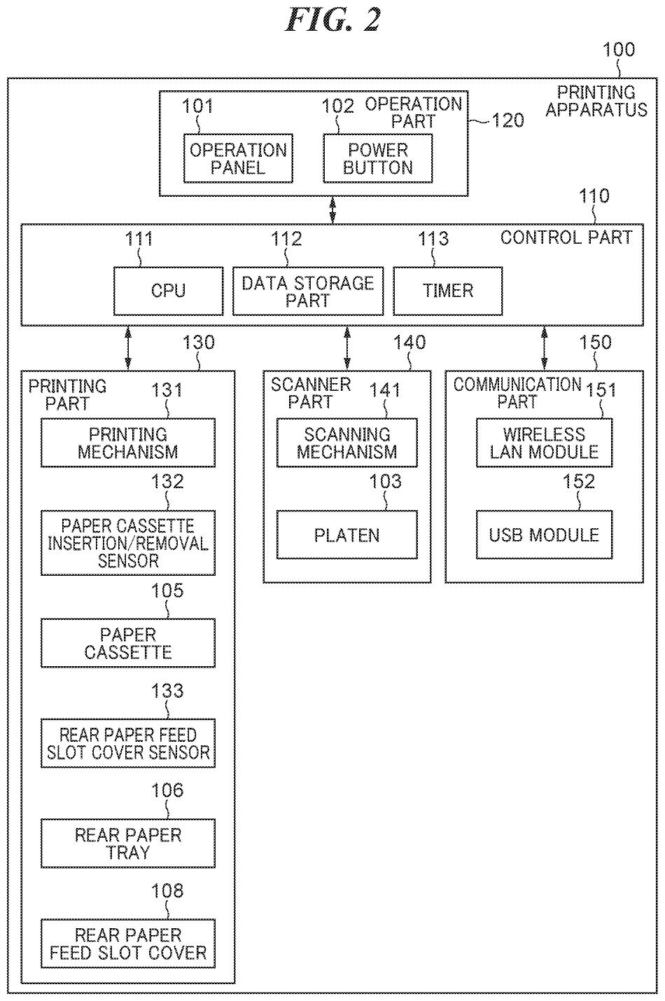

FIG. 2 is a configuration diagram of the printing apparatus 100. The printing apparatus 100 includes a control part 110, an operation part 120, a printing part 130, a scanner part 140, and a communication part 150. The control part 110 includes a CPU 111, a data storage part 112, and a timer 113, and controls the entire printing apparatus 100. The data storage part 112 includes a ROM, a RAM, and the like, and stores various programs executed by the CPU 111, image data, control data, and the like. The CPU 111 executes the programs stored in the data storage part 112 to implement various required functions. The various functions include a control function of each component of the printing apparatus 100, detection functions of various sensors, and various display functions. The timer 113 measures time. The operation part 120 includes an operation panel 101 and a power button 102 (FIG. 1). It should be noted that the operation panel 101 includes a display part such as a liquid crystal, and this display part displays guide for initial installation.

The printing part 130 includes a printing mechanism 131, a paper cassette insertion/removal sensor 132, a paper cassette 105, a rear paper feed slot cover sensor 133, a rear paper tray 106, and a rear paper feed slot cover 108. The printing mechanism 131 draws in paper from the paper cassette 105 or the rear paper tray 106, and ejects ink from the print head to execute printing. The paper cassette insertion/removal sensor 132 is a sensor that detects whether or not the paper cassette 105 is inserted into (is mounted on) the main body of the printing apparatus 100. The rear paper feed slot cover sensor 133 is a sensor that detects an open/close state of the rear paper feed slot cover 108. The paper cassette 105, the rear paper tray 106, and the rear paper feed slot cover 108 are illustrated in FIG. 1.

The scanner part 140 includes a scanning mechanism 141 and a platen 103 (FIG. 1). The scanning mechanism 141 irradiates a document set on the platen 103 with light from a light source, detects the reflected light by an optical sensor such as a CCD, and reads the document as an image. The communication part 150 includes a wireless LAN module 151 and a USB module 152. The wireless LAN module 151 is a communication module for transmitting and receiving data to and from an external device via a wireless LAN. The USB module 152 is a communication module for transmitting and receiving data to and from an external device via a USB cable.

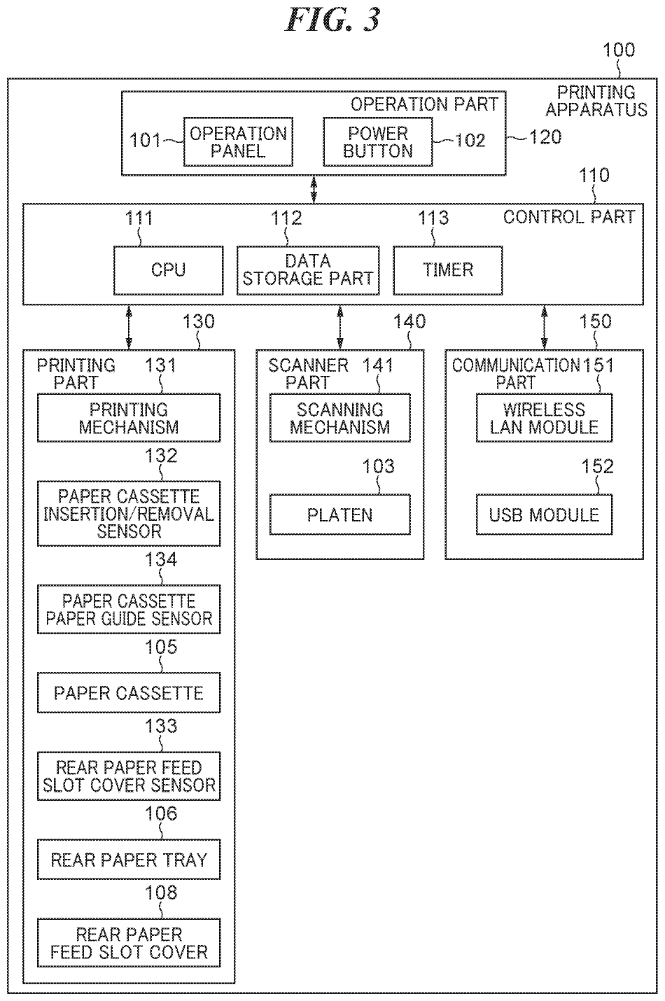

FIG. 3 is a diagram showing an example of another configuration of the printing apparatus 100. The configuration of FIG. 3 includes a “paper cassette paper guide sensor 134” in addition to the configuration of FIG. 2, and the other components are basically similar to those in FIG. 2. The paper cassette paper guide sensor 134 is interlocked with the paper cassette insertion/removal sensor 132, and detects the paper guide position of the paper cassette 105 when the paper cassette 105 is inserted in the main body of the printing apparatus 100.

The paper guide enables paper to be set in a correct position, front to back and left to right, when setting different sizes of paper, such as A4 size paper and A5 size paper into the paper cassette 105, which prevents paper feeding errors. The paper cassette paper guide sensor 134 detects the paper guide position and whether or not the paper guide is positioned so that A4 size paper, A5 size paper, letter size paper, and the like are appropriately positioned.

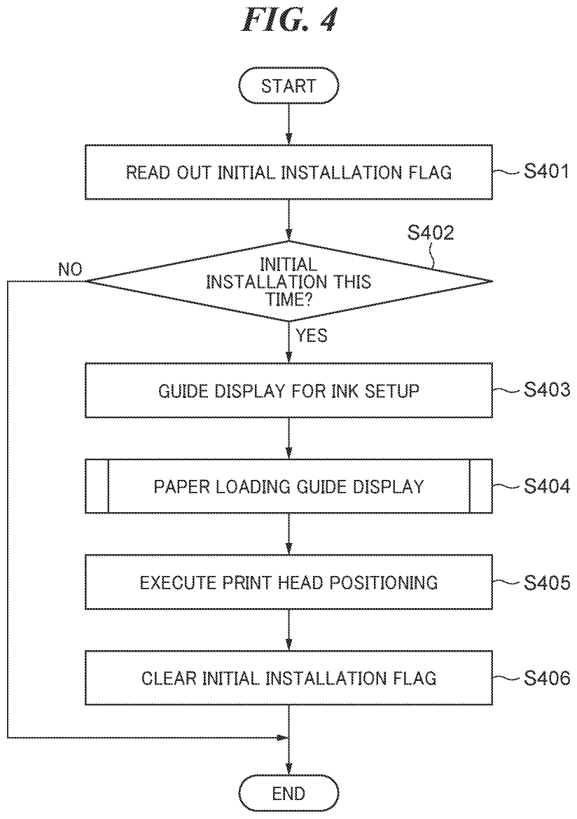

FIG. 4 is a flowchart showing an initial installation process executed by the printing apparatus 100. The initial installation process is implemented by the CPU 111 loading the control program stored in the ROM of the data storage part 112 into the RAM of the data storage part 112 and executing the control program. The initial installation process is started when the user presses (operates) the power button 102 to turn the printing apparatus 100 on.

First, in step S401, the CPU 111 reads the value of the “initial installation flag” from the data storage part 112. The value of the “initial installation flag” is either “True” indicating that the printing apparatus 100 is in the initial installation state, that is, the printing apparatus 100 is started for the first time this time, or “False” indicating that the printing apparatus 100 is not in the initial installation state, that is, this is the second or subsequent startup of the printing apparatus 100.

In step S402, in a case where the value of the “initial installation flag” read out is “True” (YES in S402), the CPU 111 determines that the printing apparatus 100 is in the initial installation state, and advances the process to step S403 to start startup control dedicated to initial installation. On the other hand, in a case where the value of the “initial installation flag” read out is “False” (NO in S402), the CPU 111 determines that the initial installation of the printing apparatus 100 is completed, and ends the present process. In this case, the initial installation is not performed, and normal startup control of the printing apparatus 100 is started.

In step S403, the CPU 111 causes the operation panel 101 to provide guide display that prompts the user to set up the ink (including setting the ink) for the printing mechanism 131. The following various displays are basically provided by the operation panel 101. In step S404, the CPU 111 provides a guide display (paper loading guide display) to cause the user to set (load) paper in the paper cassette 105 or the rear paper tray 106.

In step S405, the CPU 111 executes print head positioning using the set ink and the set paper. Specifically, the CPU 111 first draws paper from the paper cassette 105 or the rear paper tray 106, and executes test printing using a preset print pattern. Then, the CPU 111 optically reads the test printing result by the scanning mechanism 141, and optimizes the ink ejection timing based on the reading result. When the print head positioning is completed, the CPU 111 clears the “initial installation flag” in step S406. That is, the CPU 111 updates the value of “initial installation flag” to “False”. As a result, the CPU 111 executes normal startup control the next and subsequent times when the printing apparatus 100 is turned on.

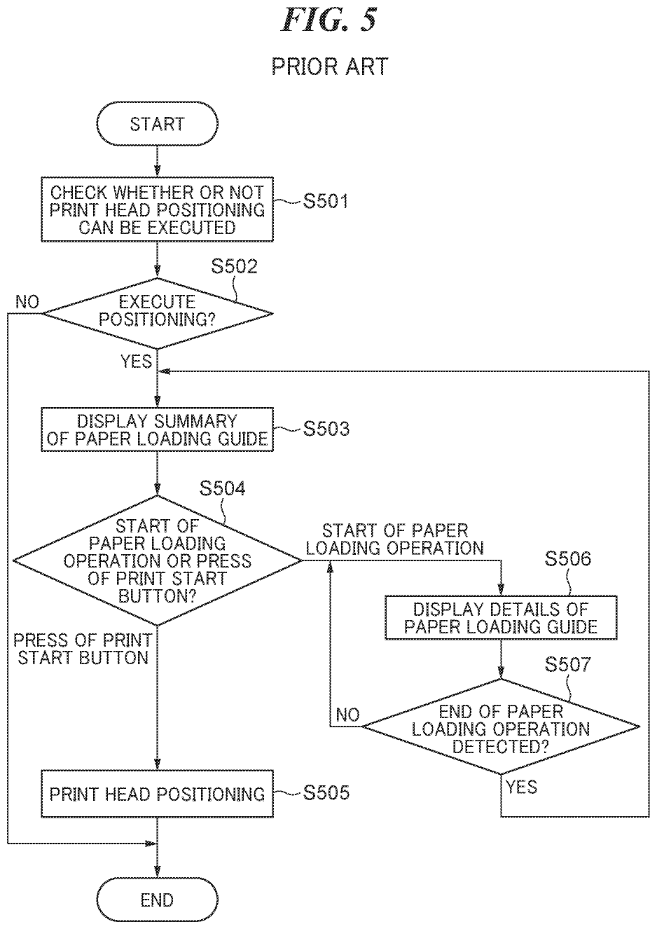

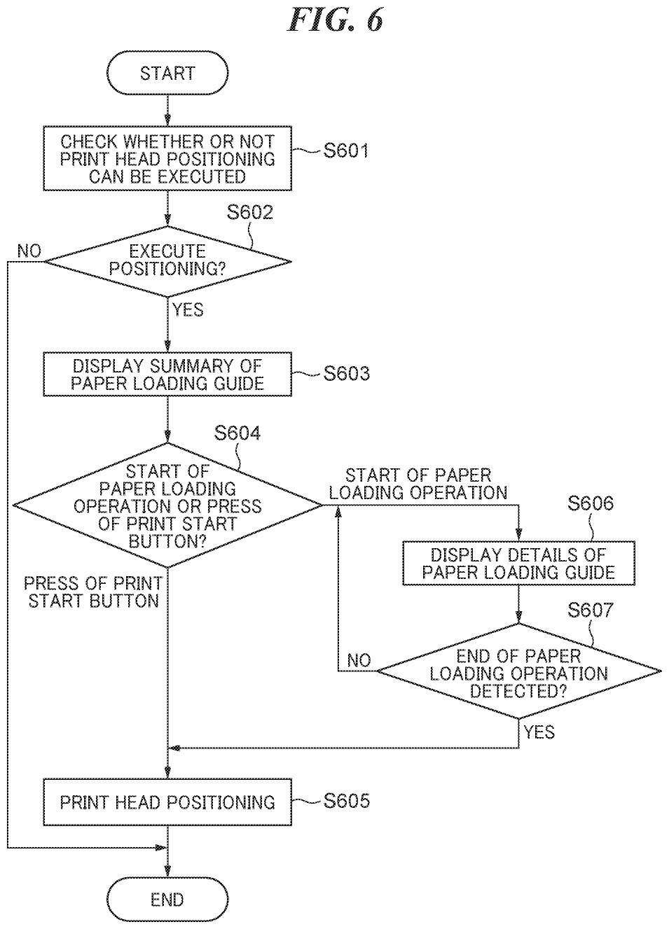

Next, details (first embodiment) of the “paper loading guide display” in step S404 in FIG. 4 will be described with reference to FIGS. 5 and 6. FIG. 5 is a flowchart showing a paper loading guide display process in the prior art. FIG. 6 is a flowchart showing a paper loading guide display process according to the first embodiment. Each of the process shown in FIGS. 5 and the process shown in FIG. 6 are started after the user follows the guide display to set up the ink (including ink setting) in step S403 in FIG. 4. First, FIG. 6 will be described, and then the difference from the process in FIG. 5 will be described.

In the first embodiment, button press detection on the operation panel 101 or “paper loading operation end detection” is required as a trigger to proceed from step S404 to step S405 in FIG. 4. The “paper loading operation end detection” is performed when the paper cassette insertion/removal sensor 132 detects that the paper cassette 105 has been inserted, or when the rear paper feed slot cover sensor 133 detects that the rear paper feed slot cover 108 has been closed.

First, in step S601, the CPU 111 checks whether or not print head positioning can be executed. That is, the CPU 111 waits for a user operation (user's instruction) to determine whether or not to execute print head positioning. When receiving the user operation, in step S602, the CPU 111 determines whether the user has selected to execute print head positioning or not. In a case where the user selects not to execute print head positioning (NO in S602), the CPU 111 ends the present process. In a case where the user selects to execute print head positioning (YES in S602), the CPU 111 advances the process to step S603.

In step S603, the CPU 111 displays a summary of the paper loading guide, and waits until the press of the print start button is detected or the start of a paper loading operation is detected. That is, the CPU 111 waits for a user operation. When receiving the user operation, the CPU 111 advances the process to step S604. In S604, in a case where it is determined that a press of the print start button by the user has been detected, the CPU 111 advances the process to step S605 to start print head positioning. Here, “print head positioning” refers to a process including one such as a process for actually printing a test pattern for print head positioning on paper. Thereafter, when the print head positioning is completed, the CPU 111 ends the present process.

In step S604, in a case where it is determined that the start of the paper loading operation by the user has been detected, the CPU 111 advances the process to step S606. Here, the detection of “start of the paper loading operation” is performed by one of the following three detection modes (1) to (3). (1) The start of the paper loading operation is detected when the paper cassette insertion/removal sensor 132 detects that the paper cassette 105 has been removed. (2) The start of the paper loading operation is detected when the rear paper feed slot cover sensor 133 detects that the rear paper feed slot cover 108 has been opened. (3) The start of the paper loading operation is detected when a button press on the operation panel 101 is detected. Next, in step S606, the CPU 111 displays details of the paper loading guide and waits until the end of the paper loading operation is detected.

That is, in step S607, the CPU 111 waits for the user to load the paper. The CPU 111 detects the end of the paper loading operation by detecting that the user has loaded the paper. In a case where the end of the paper loading operation is not detected (NO in S607), the process turns to S606, that is, the CPU 111 enters a standby state. In a case where the end of the paper loading operation is detected (YES in S607), the CPU 111 advances the process to step S605 to start the print head positioning described above. That is, the print head starts printing a test pattern on the paper. Thereafter, when the print head positioning is completed, the CPU 111 ends the present process.

Differences between the prior art and the first embodiment will be described by comparing FIGS. 5 and 6. Processes in steps S501 to S507 in FIG. correspond to processes in steps S601 to S607 in FIG. 6, whereas there is a difference between the process in step S607 in FIG. 6 and the process in step S507 in FIG. 5. In step S507 (prior art) in FIG. 5, in a case where the end of the paper loading operation is detected (YES in S507), the process proceeds to step S503. On the other hand, in S607 (the first embodiment) in FIG. 6, in a case where the end of the paper loading operation is detected (YES in S607), the process proceeds to step S605. As a result, according to the process in the first embodiment illustrated in FIG. 6, in a case where the end of the paper loading operation is detected, print head positioning can be automatically started without waiting for the user to press the print start button.

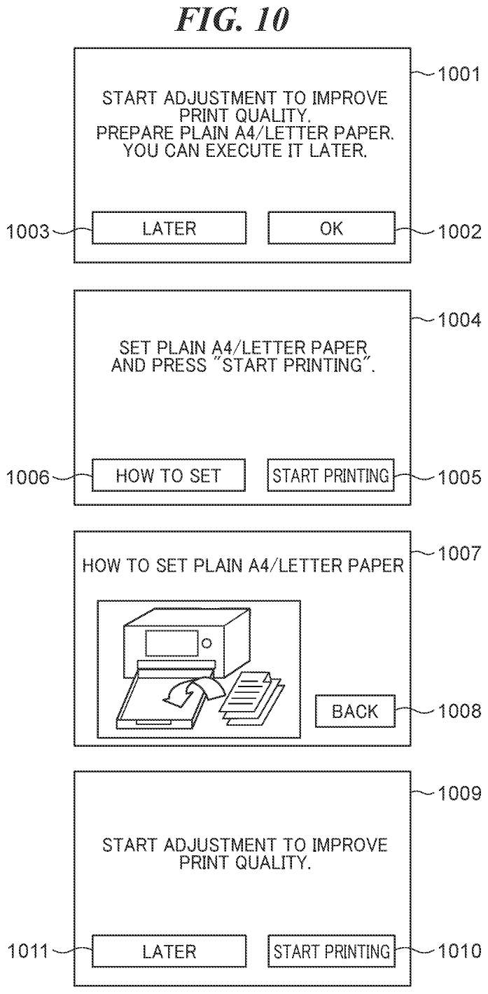

Regarding the display described with reference to FIGS. 5 and 6, the operation panel 101 of the printing apparatus 100 provides a display as illustrated in FIG. 10. The check of whether or not to execute the print head positioning in steps S501 and S601, that is, the user instruction as to whether or not to execute the print head positioning (adjustment), is performed on the display screen 1001. When a display button 1002 (“OK”) is touched by the user, print head positioning is executed, and when a display button 1003 (“Later”) is touched by the user, the print head positioning is not executed. In addition, the summary of the paper loading guide in steps S503 and S603 is displayed on the display screen 1004. When a display button 1005 (“Start Printing”) is touched by the user, “print head positioning” is executed, that is, printing of a test pattern is executed. When a display button 1006 (“How To Set”) is touched by the user, “Paper Loading Operation” is started, that is, how to set the paper (details of paper loading guide) is displayed. In addition, the details of the paper loading guide in steps S506 and S606 are displayed on the display screen 1007. When a display button 1008 (“Back”) is touched by the user, the screen one before how to set paper (paper loading method) is displayed.

Next, the second embodiment will be described. In the first embodiment (FIG. 6), in a case where the end of the paper loading operation is detected, print head positioning is automatically started without waiting for the user to press the print start button. On the other hand, in the second embodiment, when the end of the paper loading operation is detected, the process is switched according to the time required for the paper loading operation.

In the process in the first embodiment (FIG. 6), in a case where the end of the paper loading operation is detected (YES in S607), the print head positioning is automatically started. However, in some cases, a user may remove the paper cassette 105 from the main body of the printing apparatus 100 just to confirm the presence or absence of paper, and then immediately insert the paper cassette 105 into the printing apparatus 100. In this case, if paper is not set in the paper cassette 105, “No Paper Error” may be caused by the print head positioning, which is not preferable. In order to solve such a problem, in the second embodiment, when the end of the paper loading operation is detected, the process is switched according to the time required for the paper loading operation.

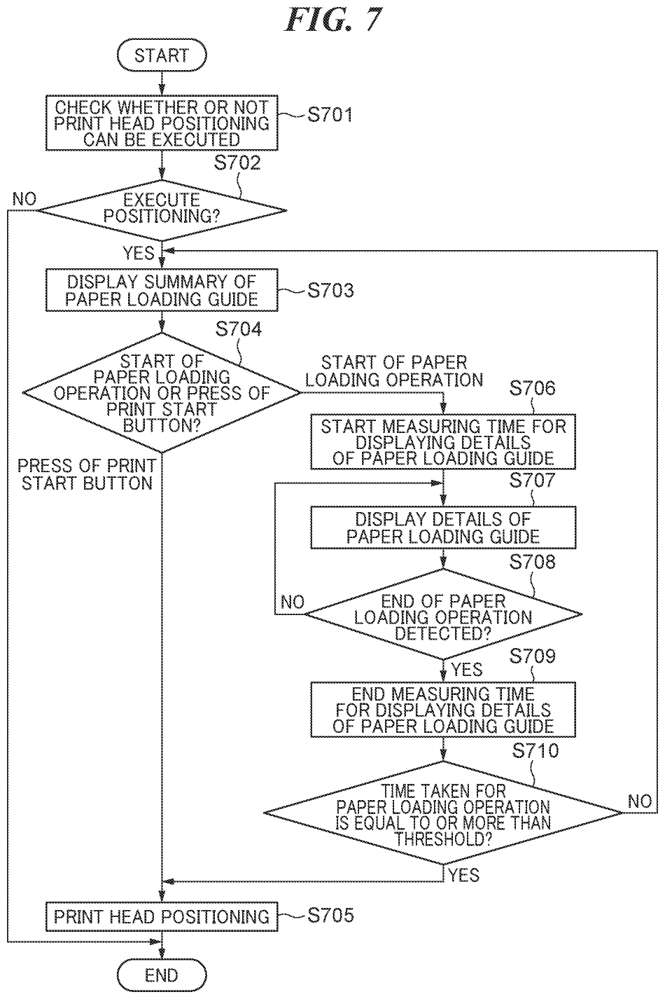

The second embodiment will be described with reference to FIG. 7 together with differences from the first embodiment. FIG. 7 is a flowchart showing a paper loading guide display process according to the second embodiment. The configurations of the printing apparatus 100 in the second embodiment are equivalent to those in the first embodiment unless otherwise specified. The description of the equivalent configuration in the second embodiment to the first embodiment will be omitted. The start condition of the process in FIG. 7 is similar to the start condition of the process in FIG. 6.

First, the CPU 111 performs processes in steps S701 to S705, which are similar to the processes in steps S601 to S605 in FIG. 6. In step S704, in a case where it is determined that the start of the paper loading operation has been detected, that is, in a case where it is determined that the user has instructed the start of the paper loading operation, the CPU 111 advances the process to step S706. In step S706, the CPU 111 starts measuring the time for displaying details of paper loading guide. Specifically, the CPU 111 controls the timer 113 to start time measurement. In step S707, the CPU 111 displays details of the paper loading guide and waits until the end of the paper loading operation is detected.

That is, in step S708, the CPU 111 waits for the user to load the paper. The CPU 111 detects the end of the paper loading operation by detecting that the user has loaded the paper. In a case where the end of the paper loading operation has been detected (YES in S708), the CPU 111 advances the process to step S709. In a case where the end of the paper loading operation is not detected (NO in S708), the process turns to S707, that is, the CPU 111 enters a standby state. In step S709, the CPU 111 controls and stops the timer 113 to ends the measurement of the time for displaying the details of the paper loading guide, and calculates the time taken to display the details of the paper loading guide (the time required from step S706 to step S709). The calculated time is regarded as the time taken by the user to perform the paper loading operation.

In step S710, the CPU 111 determines whether or not the time taken by the user to perform the paper loading operation is equal to or more than a predetermined threshold. In a case where the time taken to perform the paper loading operation is equal to or more than the predetermined threshold (YES in step S710), the CPU 111 advances the process to step S705 and starts print head positioning. That is, the CPU 111 starts, by the print head, printing a test pattern on the paper. Thereafter, when the print head positioning is completed, the CPU 111 ends the present process. On the other hand, in a case where the time taken to perform the paper loading operation is less than the predetermined threshold (NO in step S710), the CPU 111 advances the process to step S703.

Here, the predetermined threshold is preferably determined based on the user's behavior. The predetermined threshold is preferably the time longer than the time taken by the user to remove the paper cassette 105 from the main body of the printing apparatus 100 to confirm the presence or absence of paper and immediately insert the paper cassette 105 into the printing apparatus 100, and shorter than the time taken by the user to remove the paper cassette 105 from the main body of the printing apparatus 100 and immediately insert the paper cassette 105 into the printing apparatus 100 after setting paper. For example, in a case where it is assumed that it takes “1 second” to confirm the presence or absence of paper and “10 seconds” to set the paper, the predetermined threshold can be set to “3 seconds”.

As described above, according to the process of the second embodiment illustrated in FIG. 7, it may be configured to when the end of the paper loading operation is detected, the print head positioning is automatically started in a case where the time taken for the paper loading operation is long, while the print head positioning is not automatically started in a case where the time taken for the paper loading operation is short. Further, although in a case where the determination result in step S710 is “less than the predetermined threshold” (NO in step S710), the process proceeds to step S703 in the present embodiment, the process may proceed to step S706.

In addition, the detection of “start of paper loading operation” in step S704 of the present embodiment may be limited to some of the three detection modes (1) to (3) for step S604 in the first embodiment. For example, in a case where the detection mode (3) is adopted and the start of the paper loading operation is detected as a result of the detection of the press of the button on the operation panel 101, it may be automatically considered to be “equal to or more than the predetermined threshold” in step S710 without time measurement, and the determination result may be set to “YES”. Alternatively, when the paper cassette 105 is removed in step S707, time measurement may be started from that time. In this case, in step S709, the time taken from the removal of the paper cassette 105 in step S707 to step S709 may be calculated.

Next, the third embodiment will be described. In the first embodiment (FIG. 6), the print head positioning is automatically started by the end of the paper loading operation being detected. On the other hand, in the third embodiment, in a case where it is determined that the paper loading operation has been finished in advance, the print head positioning is automatically started without the paper loading guide display.

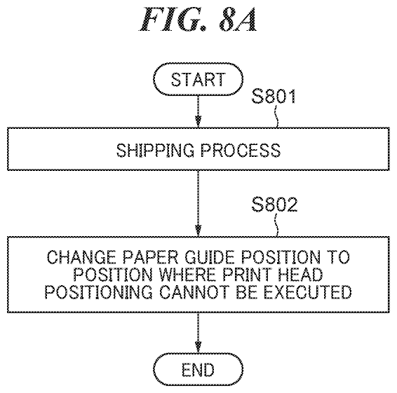

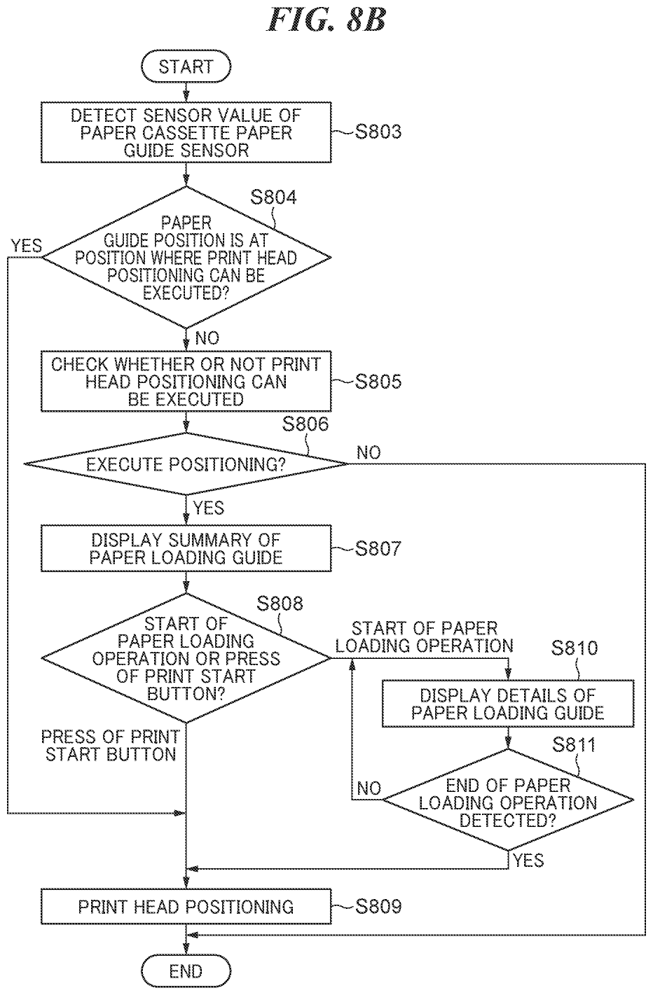

FIGS. 8A and 8B are flowcharts for describing paper loading guide display processes according to the third embodiment. With reference to FIGS. 8A and 8B, the third embodiment will be described together with differences from the first embodiment. The configurations of the printing apparatus 100 in the third embodiment are equivalent to those in the first embodiment unless otherwise specified. The description of the equivalent configuration in the third embodiment to the first embodiment will be omitted. It should be noted that the configuration of the present embodiment includes a paper cassette paper guide sensor 134 (FIG. 3).

Processes in steps S801 and S802 in FIG. 8A are performed by an operator at the time of producing the printing apparatus 100 in the factory. Processes in step S803 and subsequent steps in FIG. 8B are performed by the user who has purchased the printing apparatus 100. The start condition for the process in FIG. 8B (step S803) is similar to the start condition of the process in FIG. 6. First, in step S801, various shipping processes are performed in the factory. Next, in step S802, the paper guide position of the paper cassette is changed (set) to a position where the print head positioning cannot be executed, followed by packaging and shipping.

Then, the user purchases and unpacks the printing apparatus 100, presses (operates) the power button 102 to turn the printing apparatus 100 on, and performs initial installation (see FIG. 4). In step S403, after the user performs the ink setup (including ink setting) according to the guide display, the CPU 111 starts S803. In step S803, the CPU 111 detects a sensor value of the paper cassette paper guide sensor 134. Next, in step S804, the CPU 111 determines whether or not the paper guide position is at a position where the print head positioning can be executed based on the detected sensor value. Here, for example, if the width of the paper guide matches the width of the paper used for printing, the CPU 111 determines that the paper guide position is at a position where the print head positioning can be executed.

In a case where it is determined that the paper guide position is at a position where the print head positioning can be executed (YES in S804), the CPU 111 advances the process to step S809 to start print head positioning. That is, printing by the print head is started. Thereafter, when the print head positioning is completed, the CPU 111 ends the present process. On the other hand, in a case where it is determined that the paper guide position is not at a position where print head positioning can be executed (NO in S804), the CPU 111 advances the process to step S805. Then, the CPU 111 performs processes in steps S805 to S811, which are similar to the processes steps S601 to S607 in FIG. 6.

As described above, according to the processes of the third embodiment illustrated in FIGS. 8A and 8B, in a case where it is determined that the paper loading operation has been finished in advance, the print head positioning can be automatically started without the paper loading guide display.

Next, the fourth embodiment will be described. In the third embodiment, in a case where it is determined that the paper loading operation has been finished in advance, the print head positioning is automatically started without the paper loading guide display. On the other hand, in the fourth embodiment, in a case where it is determined that the paper loading operation has been finished in advance, the content of the paper loading guide display is switched to another display content.

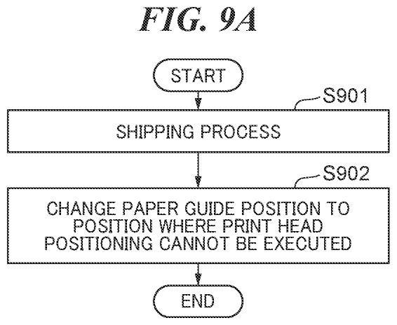

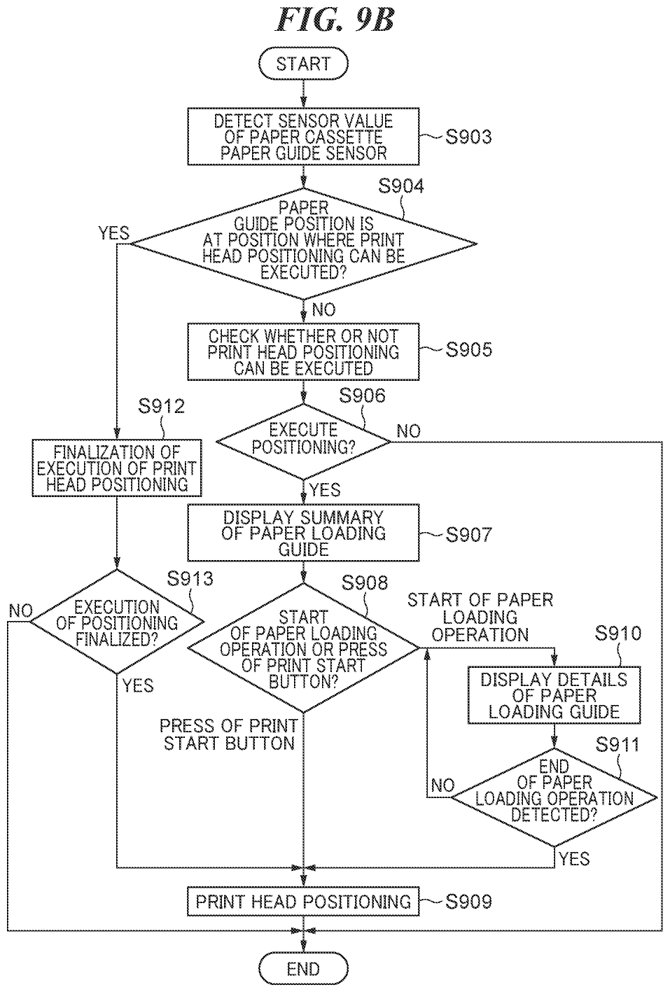

FIGS. 9A and 9B are flowcharts for describing paper loading guide display processes according to the fourth embodiment. With reference to FIGS. 9A and 9B, the fourth embodiment will be described together with differences from the third embodiment. The configurations of the printing apparatus 100 in the fourth embodiment are equivalent to those in the third embodiment unless otherwise specified. The description of the equivalent configuration in the fourth embodiment to the third embodiment will be omitted. It should be noted that the configuration of the present embodiment includes a paper cassette paper guide sensor 134 (FIG. 3). The processes in the factory in FIG. 9A (S901 and S902) are similar to those illustrated in FIG. 8A (S801 and S802). Processes in S903 to S911 in FIG. 9B are similar to the processes in S803 to S811 in FIG. 8B, and therefore the description thereof is omitted.

However, in a case where it is determined, based on the detected sensor value in step S904, that the paper guide position is at a position where the print head positioning can be executed (YES in S904), the CPU 111 advances the process to step S912. Here, for example, if the width of the paper guide matches the width of the paper used for printing, the CPU 111 determines that the paper guide position is at a position where the print head positioning can be executed. Next, in step S912, the CPU 111 executes finalization of the execution of print head positioning, and advances the process to step S913. It should be noted that in this finalization, the CPU 111 switches the guide display as described later (FIG. 10). In step S913, the CPU 111 waits for a user operation. Then, in a case where it is determined that the user has selected not to execute print head positioning (NO in S913), the CPU 111 ends the present process. On the other hand, in a case where it is determined that the user has selected to execute print head positioning (YES in S913), the CPU 111 advances the process to step S909 to start (execute) print head positioning. That is, printing by the print head is started. Thereafter, when the print head positioning is completed, the CPU 111 ends the present process.

As described above, according to the processes illustrated in FIGS. 9A and 9B, in a case where it is determined that paper loading operation has been finished in advance, the content of the paper loading guide display can be switched to another display content. The display described in FIG. 9B is provided on the operation panel 101 of the printing apparatus 100 as illustrated in FIG. 10. The finalization of the execution of the print head positioning in step S912 is performed via a display screen 1009. When a display button 1010 (“Start printing”) is touched by the user, printing is executed, and when a display button 1011 (“Later”) is touched by the user, printing is not executed.

Another embodiment will be described. In the third embodiment and the fourth embodiment, whether or not the paper loading operation has been finished in advance is determined by using the paper cassette paper guide sensor 134. In a printing apparatus not including the paper cassette paper guide sensor 134, the paper cassette insertion/removal sensor 132 may be used to determine whether or not the paper loading operation has been finished in advance. Namely, in steps S401 to S403 in FIG. 4, in a case where the CPU 111 detects the end of the paper loading operation, the CPU 111 stores the detection of the “end” of the paper loading operation in the data storage part 112. Then, in step S804 and step S904, in a case where the data storage part 112 stores the detection of the “end”, the CPU 111 may advance the process to step S809 from step S804, or step S912 from step S904.

According to the another embodiment described above, in a case where the end of the paper loading operation is detected before the guide display is provided (guide information is displayed) via the operation panel 101, the CPU 111 can execute the process of starting printing without displaying the guide information on the operation panel 101. In addition, the CPU 111 can also execute the process of changing the content of the guide information on the operation panel 101 in a case where the end of the paper loading operation is detected before the guide information is displayed.

Variation (1) will be described. The processes in the first embodiment to the fourth embodiment can also be executed by a mobile terminal (smartphone, tablet terminal) and the printing apparatus 100 communicating information with each other. In this case, for example, a dedicated application downloaded from a specific website is installed on the mobile terminal in advance. For example, processes in steps S606 and S607 in FIG. 6 can be executed by a dedicated application. The process in FIG. 6 is implemented as follows: in step S606, the details of the paper loading guide are displayed on the mobile terminal by the dedicated application; and in S607, the user inputs information indicating that the paper loading operation is finished into the mobile terminal and transmits the information to the printing apparatus.

Variation (2) will be described. For example, processes in S603 and S606 in FIG. 6 can be implemented by connecting a PC and the printing apparatus 100 via a USB cable, and clicking a specific display button of a specific website using the PC. According to this aspect, it is possible to view the guide information on a larger screen, and it is further possible, by adding voice information, to further improve the operability of the initial installation work for the user. It should be noted that a configuration can be adopted, in which a character or the like may appear on the screen displaying the guide information and take action promoting attention. Alternatively, using a configuration in which the user wears goggles for three-dimensional images connected to a PC and three-dimensional images appear on the screen, an avatar of a pre-created three-dimensional image of the user may appear on the screen and talk while performing actions to introduce the initial installation work guide information.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-169994, filed Oct. 24, 2022, which is hereby incorporated by reference wherein in its entirety.

What is claimed is:

1. A printing apparatus capable of displaying guide summary information for paper loading guide at the time of initial installation of the printing apparatus, the printing apparatus comprising:
one or more controllers configured to function as:
a first detection unit configured to detect start of paper loading operation;
a second detection unit configured to detect end of the paper loading operation;
a guide display unit configured to display more detailed guide information than the guide summary information in a case where the start of the paper loading operation is detected at the time of the initial installation of the printing apparatus; and
a control unit configured to control, after the display of the guide information is started, to start printing in a case where the end of the paper loading operation is detected, and not to start printing in a case where the end of the paper loading operation is not detected.

2. The printing apparatus according to claim 1,
wherein in a case where the control unit controls not to start printing, the guide display unit continues to display the guide information until the end of the paper loading operation is detected.

3. The printing apparatus according to claim 1, further comprising:
a time measurement unit configured to measure paper loading time taken from the detected start of the paper loading operation to the detected end of the paper loading operation,
wherein, at the time of initial installation of the printing apparatus, the control unit controls to start printing triggered by the detected end of the paper loading operation in a case where the measured paper loading time is equal to or more than a predetermined threshold, and not to start printing triggered by the detected end of the paper loading operation in a case where the measured paper loading time is less than the predetermined threshold.

4. The printing apparatus according to claim 1, further comprising:
a guide width detection unit configured to detect a width of a paper loading guide,
wherein at the time of initial installation of the printing apparatus, in a case where the detected width of the paper loading guide matches the width of the paper to be used for printing, the control unit controls to start printing even if the guide information is not displayed.

5. The printing apparatus according to claim 1, further comprising:
a guide width detection unit configured to detect a width of a paper loading guide,
wherein at the time of initial installation of the printing apparatus, in a case where the detected width of the paper loading guide matches the width of paper to be used for printing, the guide display unit changes the content of the guide information to be displayed.

6. The printing apparatus according to claim 1, further comprising:
a third detection unit configured to detect that the paper loading operation has been finished in advance,
wherein at the time of initial installation of the printing apparatus, in a case where it is detected that the paper loading operation has been finished in advance, the control unit controls to start printing even if the guide information is not displayed.

7. The printing apparatus according to claim 1, further comprising:
a third detection unit configured to detect that the paper loading operation has been finished in advance,
wherein at the time of initial installation of the printing apparatus, in a case where it is detected that the paper loading operation has been finished in advance, the guide display unit changes the content of the guide information to be displayed.

8. A control method for a printing apparatus capable of displaying guide summary information for paper loading guide at the time of initial installation of a printing apparatus, the control method comprising:
detecting start of paper loading operation;
detecting end of the paper loading operation;
displaying more detailed guide information than the guide summary information in a case where the start of the paper loading operation is detected at the time of the initial installation of the printing apparatus; and
controlling, after the display of the guide information is started, to start printing in a case where the end of the paper loading operation is detected, and not to start printing in a case where the end of the paper loading operation is not detected.

9. A non-transitory computer-readable storage medium storing a program for causing a computer to execute a control method for a printing apparatus capable of displaying guide summary information for paper loading guide at the time of initial installation of a printing apparatus,
the control method comprising:
detecting start of paper loading operation;
detecting end of the paper loading operation;
displaying more detailed guide information than the guide summary information in a case where the start of the paper loading operation is detected at the time of the initial installation of the printing apparatus; and
controlling, after the display of the guide information is started, to start printing in a case where the end of the paper loading operation is detected, and not to start printing in a case where the end of the paper loading operation is not detected.
